(19) United States
(12) Patent Application Publication
(10) Pub. No.: US 2014/0287266 A1
(43) Pub. Date: Sep. 25, 2014

(54) PATTERN FORMING METHOD AND MANUFACTURING METHOD OF MAGNETIC RECORDING MEDIUM

(71) Applicant: Kabushiki Kaisha Toshiba, Tokyo (JP)

(72) Inventors: Akira WATANABE, Kanagawa (JP); Kazutaka TAKIZAWA, Kanagawa (JP); Kaori KIMURA, Kanagawa (JP)

(73) Assignee: Kabushiki Kaisha Toshiba, Tokyo (JP)

(21) Appl. No.: 14/017,217

(22) Filed: Sep. 3, 2013

(30) Foreign Application Priority Data
Mar. 22, 2013 (JP) 2013-060656

(51) Int. Cl. G11B 5/84; G11B 5/74

(52) U.S. Cl. CPC G11B 5/84; G11B 5/743
USPC 428/800; 216/67; 216/22

(57) ABSTRACT

According to exemplary embodiments, a pattern forming method includes: forming a diblock copolymer coating film by applying coating liquid containing a diblock copolymer including a chain of a first polymer and a chain of a second polymer which is not compatible with the first polymer, and a homopolymer having affinity with the first polymer, on a substrate, and drying the liquid; and performing phase separation of the first polymer and the second polymer by providing a coating film for solvent annealing using a solvent having compatibility with the second polymer.

### CROSS-REFERENCE TO RELATED APPLICATION

This application is based upon and claims the benefit of priority from Japanese Patent Application No. 2013-060656, filed Mar. 22, 2013, the entire contents of which are incorporated herein by reference.

### FIELD

Embodiments described herein relate to a pattern forming method and a manufacturing method of a magnetic recording medium.

### BACKGROUND

Forming a minute concavo-convex pattern in a surface is performed in technical fields such as a contact hole forming technology of a hard disk medium, an antireflection film, a catalyst, a microchip, an optical device, and a semiconductor. In one aspect herein, the term concavo-convex pattern means a pattern in a film layer formed by removing a portion of the film layer to yield a pattern of recesses (the concave portion) extending inwardly of mesas or non-removed portions of the film layer.

With the increase of recording density of a magnetic recording apparatus, patterned media (BPM; Bit Patterned Media) are proposed as a magnetic recording medium for achieving a high recording density. It is possible to obtain a patterned medium by processing a surface of a recording layer of a hard disk medium in a minute concavo-convex form. In the patterned medium, it is important how the concavo-convex pattern is manufactured. It is known that a self-assembled process can be used in order to manufacture cyclic concavities and convexities.

In one method of self-assembled lithography using a diblock copolymer, a minute pattern of several nm to several tens nm may be formed with low cost, using a micro phase-separated structure formed by performing thermal annealing on the diblock copolymer (a lamella, cylinder, or sphere structure).

In recent years, with continued miniaturization of the patterns, it is proposed to use solvent annealing in which a solvent is contained in a polymer and phase separation is performed to form the pattern, rather than continuing to use the thermal annealing approach.

The phase separated shape of a diblock copolymer has different stable shapes depending on a volume fraction of each polymer. Accordingly, in the solvent annealing process, the volume fraction of each polymer changes depending on the amount of solvent contained in the polymer, and the problem of changing the phase separated shape results.

### DESCRIPTION OF THE DRAWINGS

FIG. 1 is a schematic view for explaining an action of a pattern forming method according to an exemplary embodiment.

FIG. 2 is a view showing a manufacturing step of a magnetic recording medium according to an exemplary embodiment.

FIG. 3 is a view showing an example of a recording bit pattern with respect to a circumferential direction of a magnetic recording medium.

### DETAILED DESCRIPTION

An object of exemplary embodiments described herein is to provide an excellent minute pattern.

According to an exemplary embodiment, there is provided a pattern forming method including: forming a diblock copolymer coating film by applying coating liquid containing (i) a diblock copolymer including a chain of a first polymer and a chain of a second polymer which is not compatible with the first polymer, and (ii) a homopolymer having affinity with the first polymer, on a substrate, and drying the liquid; performing phase separation on the resulting thin film of the first polymer and the second polymer by using a solvent having compatibility with the second polymer; and forming a concavo-convex pattern on the substrate by removing any one of the first polymer and the second polymer.

Hereinafter, exemplary embodiments will be described in more detail.

A pattern forming method according to an exemplary embodiment includes: forming a diblock copolymer coating film by applying coating liquid containing (i) a diblock copolymer including a chain of a first polymer and a chain of a second polymer which is not compatible with the first polymer, and (ii) a homopolymer, on a substrate, and drying the liquid; performing phase separation of the first polymer and the second polymer on the resulting film using a solvent having compatibility with the second polymer; and forming a concavo-convex pattern on the substrate by removing any one of the first polymer and the second polymer.

In this embodiment, the homopolymer has affinity with the first polymer, and the solvent used for the solvent annealing has compatibility with the second polymer.

According to the exemplary embodiment, when the volume fraction of the diblock copolymer is changed by solvent annealing, the changed parts can be complemented with the homopolymer.

The content of the homopolymer is preferably 0.1% by weight to 20% by weight with respect to the total amount of the diblock copolymer and the homopolymer.

If the content of the homopolymer is less than 0.1% by weight, variation occurs in an existing ratio of additive polymers existing in a pattern which is expressed at the time of the phase separation, and uniform pattern formation is disturbed, and thus, the arrangement tends to be disarranged. If the content of the homopolymer exceeds 20% by weight, macro phase separation occurs in the pattern and the minute pattern tends to be disarranged, i.e., improperly formed.

The solvent to be used for the solvent annealing is preferably a solvent which dissolves only a continuous phase of the polymer thin film after the phase separation. By dissolving only the continuous phase of the diblock copolymer layer, it is possible to segregate the homopolymer to the other specified form, for example, a spherical phase or a cylindrical phase. Accordingly, it is possible to increase element density in the pattern of the spherical phase or the cylindrical phase, and it is possible to increase etching resistance of the remaining film.

The diblock copolymer is preferably polystyrene-polydimethylsiloxane (PS-PDMS).

By using PDMS containing silicon (Si) for the diblock copolymer, it is possible to improve mask etch resistance.

As the homopolymer to be added, a polymer containing Si can be used.

By adding a Si compound to PS-PDMS, it is possible to increase Si concentration of the pattern to be formed by PDMS, and to improve the etching resistance.

The pattern forming method according to the exemplary embodiment can be applied to patterning of a magnetic recording medium.

A manufacturing method of a magnetic recording medium according to the exemplary embodiment includes: forming a magnetic recording layer on a substrate; forming a mask layer on the magnetic recording layer; forming a convex pattern in a film deposited or formed on the mask layer; transferring the convex pattern to the mask layer; etching the magnetic recording layer through the mask layer of the convex pattern; and removing the mask layer.

A step of forming the convex pattern includes: forming a diblock copolymer coating film by applying coating liquid containing a diblock copolymer including a chain of a first polymer and a chain of a second polymer which is different from the first polymer and also a homopolymer, on the mask layer, and drying the liquid; performing phase separation of the first polymer and the second polymer using a solvent having compatibility with the second polymer; and forming a convex pattern on the substrate by removing any one of the first polymer and the second polymer.

The homopolymer has affinity with the first polymer.

The solvent used for the solvent annealing has compatibility with the second polymer.

By applying the pattern forming method according to the exemplary embodiment to patterning of a magnetic recording medium, it is possible to manufacture a magnetic recording medium with high density of equal to or more than 1 Tbpsi (tera byte per square inch).

By being exposed to the solvent atmosphere, examples of the diblock copolymer which expresses micro phase separated shapes include polybutadiene-block-polydimethylsiloxane, polybutadiene-block-poly-4-vinylpyridine, polybutadiene-block-polymethyl methacrylate, polybutadiene-block-poly-t-butyl methacrylate, polybutadiene-block-poly-t-butyl acrylate, polybutadiene-block-poly sodium acrylate, polybutadiene-block-polyethylene oxide, poly-t-butyl methacrylate-block-poly-4-vinylpyridine, polyethylene-block-polymethyl methacrylate, poly-t-butyl methacrylate-block-poly-2-vinylpyridine, polyethylene-block-poly-2-vinylpyridine, polyethylene-block-poly-4-vinylpyridine, polyisoprene-block-poly-2-vinylpyridine, poly-t-butyl methacrylate-block-polystyrene, polymethyl acrylate-block-polystyrene, polybutadiene-block-polystyrene, polyisoprene-block-polystyrene, polystyrene-block-poly 2-vinylpyridine, polystyrene-block-poly-4-vinylpyridine, polystyrene-block-polydimethylsiloxane, polystyrene-block-poly-N,N-dimethylacrylamide, polystyrene-block-polyethylene oxide, polystyrene-block-polysilsesquioxane, polymethyl methacrylate-block-polysilsesquioxane, polystyrene-block-polymethyl methacrylate, poly-t-butyl methacrylate-block-polyethylene oxide, polystyrene-block-polyacrylic acid, and the like.

In particular, since polystyrene-block-polydimethylsiloxane, polystyrene-block-polyethylene oxide, polystyrene-block-polysilsesquioxane, and polymethyl methacrylate-block-polysilsesquioxane have large interaction parameters between respective polymers which are copolymerized with each other, the range of choice for the solvent which dissolves only one of the polymers is expanded, and thus, they are excellent as materials to be used in the exemplary embodiment. Further, since polystyrene-block-polydimethylsiloxane, polystyrene-block-polysilsesquioxane, and polymethyl methacrylate-block-polysilsesquioxane contain silicon in one of polymers, the etching resistance is high, and they are particularly effective when used as an etching mask material.

The volume fractions of the first and second polymers of the diblock copolymer to be used is preferably adjusted so that the polymer with higher etching resistance among the first and second polymers forms an island shape or a cylinder shape upon separation.

In detail, when using polystyrene-block-polysilsesquioxane, polymethyl methacrylate-block-polysilsesquioxane, polystyrene-block-polydimethylsiloxane, it is preferable that the volume fraction of polydimethylsiloxane or polysilsesquioxane having high etching resistance be 10% to 35% and polysilsesquioxane or polydimethylsiloxane upon the phase separation step form an island shape or a cylinder shape. When the volume fraction of polydimethylsiloxane or polysilsesquioxane is high and polystyrene and polymethyl methacrylate having low etching resistance are subject to phase separation to form an island shape or a cylinder shape, it is possible to reverse the concavo-convex shape by performing vapor deposition of a material over the pattern followed by liftoff or the like.

For a coating solvent which dissolves the diblock copolymer, a solvent is selected which can dissolve both the first and second polymers comprising the diblock copolymer. For example, propyl acetate; propylene glycol-1-methyl ether acetate (PGMEA), butyl acetate, ethyl acetate, methyl acetate, toluene, anisole, cyclohexanone, and the like are used. In particular, PGMEA, anisole, and cyclohexanone have a boiling point of about 150° C., and thus, they are preferable as a dispensable solvent to be dispensed as a coating on the polymer layer using spin coating, from a viewpoint of a drying speed. In addition, the exemplary embodiment is not limited only to these solvents, and any solvent can be used as long as it is a solvent which dissolves the diblock copolymer.

As the annealing solvent to be used at the time of the phase separation process, a solvent which dissolves only polystyrene or polymethyl methacrylate may be used, and a solvent having high polarity, for example, N, N-dimethylacetamide, N-methylpyrrolidone, N,N-dimethylformamide, benzyl alcohol, diethylene glycol, or the like is used. In addition, the exemplary embodiment is not limited only to these solvents, and any solvent can be used as long as it is a solvent which dissolves only polystyrene or polymethyl methacrylate.

As the homopolymer to be added, a polymer which dissolves only in polysilsesquioxane or polydimethylsiloxane may be selected. That is, a polymer having low polarity may be used, and for example, polymers having siloxane, silsesquioxane, and Spin-On Glass as a skeleton are used. In a range of not degrading solubility, a functional group such as a hydroxyl group, carbonyl group, methoxy group or the like may be substituted. In particular, a polymer which is substituted with a hydroxyl group or methoxy group is preferably used. If the polymer which is substituted with a hydroxyl group or methoxy group is used, in a step of performing pattern formation by radical etching, a cross-linking reaction of the polymers proceeds, and functionality of the resulting layer as an etching mask tends to be improved.

When using polystyrene-block-polyethylene oxide as the diblock copolymer, the volume fraction of the polyethylene oxide is preferably adjusted so that the polyethylene oxide will form in an island shape or a cylinder shape. When a polystyrene side upon phase separation forms an island shape or a cylinder shape, in a step of pattern transferring, by introducing the step of concavo-convex reverse, it is possible to control the concavo-convex shape.

As the coating solvent, tetrahydrofuran, cyclohexanone, methanol, ethanol, benzyl alcohol, cyclohexanol, cyclopentanone, and the like which dissolve both polymers are used.

As the annealing solvent to be used at the time of annealing to cause phase separation, PGMEA, butyl acetate, toluene, and the like which dissolve only polystyrene are used.

As the polymer to be added, Spin-On Glass, ionic metal complex or the like which is dissolved only to the polyethylene oxide side is used.

“Relationship Between Annealing Temperature and Molecular Weight”

A solvent annealing step of expressing a phase separation shape will be described.

Solvent annealing is a step of generating a phase separation structure by storing or exposing a sample under a solvent atmosphere. By introducing the annealing solvent in a polymer film, in the sample exposed under the solvent atmosphere, a glass transition temperature of the polymer is decreased. In conditions in which the glass transition temperature is lower than the process temperature, movement and diffusion of the polymer occur, and a phase separation structure is formed.

The time necessary for completing the phase separation is correlated with a coefficient of diffusion of the polymer. When the process temperature is equal to or higher than the glass transition temperature, the diffusion of the polymer can be considered by approaching a substance diffusion theory in polymer gel, and a coefficient of diffusion D₀ can be represented by a relationship of the following Expression (1).

D₀∝k_{B}T/6πM^{ν} (1)

(kB: Boltzmann constant, T: absolute temperature, M: molecular weight, ν: constant)

The coefficient of diffusion is proportional to the temperature, that is, the process temperature, and is predisposed to be inversely proportional to the molecular weight. Accordingly, in a case of the polymer having a large molecular weight, there are problems that the coefficient of diffusion is decreased and the time necessary for the phase separation becomes longer. Thus, by increasing the process temperature with respect to the material having a large molecular weight of the polymer, it is possible to increase the coefficient of diffusion and to solve the problem of the long period time of the phase separation step.

On the other hand, in the polymer having a small molecular weight, the coefficient of diffusion becomes larger than necessary in the process at room temperature, and a problem occurs that a thin film shape formed by the coating cannot be maintained. In this case, by decreasing the process temperature to be equal to or less than room temperature, to enable a small coefficient of diffusion, the problem can be solved.

From experience, when a diblock copolymer having a molecular weight of equal to or more than 30,000, particularly equal to or more than 50,000 is subject to the phase separation by solvent annealing, the process temperature is desirably increased to about 50° C. to 200° C., and when a diblock copolymer having a molecular weight of equal to or less than 10,000, particularly equal to or less than 8,000 is subject to the phase separation by the solvent annealing, the process temperature is desirably decreased to about 0° C. to −50° C.

In addition, during the phase separation, it is also necessary to control the amounts of the annealing solvent which is introduced into the thin film configured by the diblock copolymer. According to the amounts of the solvent to be introduced, the decrease of the glass transition temperature of the polymer occurs and the coefficient of diffusion is increased. Accordingly, based on the amounts of the solvent to be introduced to the diblock copolymer thin film, it is necessary to control the process temperature to adjust the coefficient of diffusion of the polymer. In addition, since the vapor pressure of the solvent in a chamber which causes the phase separation becomes equal to or more than a saturated vapor pressure, with the rapid temperature decrease, and there is a problem of generation of condensates of the solvent, and it is necessary to be careful when setting and changing the temperature of the coating and the solvent.

Film Thickness Uniformity Evaluation of Diblock Copolymer Thin Film

A film thickness uniformity evaluation of the diblock copolymer thin film will be described. When forming a thin film of the diblock copolymer on a substrate by a spin coating method, on a disk with a hole penetrating through the center of the substrate, a problem occurs in the precision of the formation start position of a thin film which is the dropping position of the coating solution onto the disk near the center of the disk which then traces outwardly to an outer periphery of the disk. In addition, variation of the film thickness in a substrate radial direction may occur. Accordingly, the evaluation was performed under the following conditions, with the two criteria described above.

Movement Amount of Formation Start Position of Thin Film

| | |
|---|---|
| 0 mm to 0.5 mm | ⊙ (excellent) |
| 0.5 mm to 1 mm | ◯ (good) |
| 1 mm to 3 mm | Δ (bad) |
| 3 mm or more | X (very bad) |

In addition, x and Δ represent the results not satisfying the requirement.

Variation Amount of Film Thickness in Radial Direction

| | |
|---|---|
| 5% or less | ◯ (good) |
| 5% to 10% | Δ (bad) |
| 10% or more | X (very bad) |

In addition, x and Δ represent the results having possibilities of degraded flatness of a film by generation of a multistage structure by the phase separation.

### EXAMPLES

Hereinafter, Examples are shown and the exemplary embodiment will be described in more detail.

In addition, hereinafter, the exemplary embodiment will be described in more detail with reference to the drawings.

### Example 1

### Example of Self-Assembly Having Additive

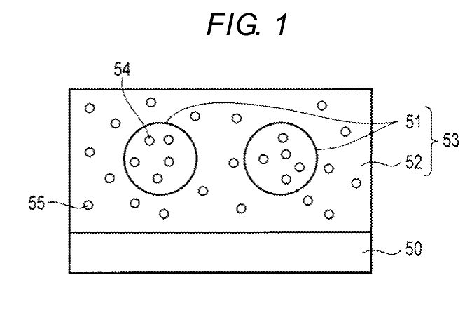

FIG. 1 shows a schematic view for explaining an action of the pattern forming method according to the exemplary embodiment.

In Example 1, a polymer thin film 53 includes a pattern in which spherical phases 51 formed of polydimethylsiloxane (PDMS) are arranged in a continuous phase 52 formed of polystyrene (PS) formed on a substrate 50.

Homopolymers 54 are introduced to PDMS of the spherical phases 51 according to the amounts of solvents 55 introduced to PS of the continuous phase 52, and it is possible to suppress the change of the volume fraction thereof. In addition, the homopolymers 54 introduced into the PDMS also function to increase the density of the spherical phases 51 and thus the etching resistance of the resulting convexo-concave patterning film can be increased.

In the exemplary embodiment, a diblock copolymer in which the monomers are formed of PS and PDMS (PS-b-PDMS) was used. In addition, PDMS having a hydroxyl group on a termination was used as a homopolymer to be added. PDMS having a hydroxyl group on a termination to be added is one of homopolymers configuring PS-b-PDMS which is a diblock copolymer and is a silicon compound.

A diblock copolymer and PDMS having a hydroxyl group on a termination were used as will be described hereinafter in detail.

First, regarding the number average molecular weight Mn of each block chain configuring PS-b-PDMS, the number average molecular weight Mn of the PS block chain was 11,800, the number average molecular weight Mn of the PDMS block chain was 2,000, and the molecular weight variation Mw/Mn was 1.12. In addition, the number average molecular weight Mn of PDMS having a hydroxyl group on a termination to be added was 3,600, and the molecular weight variation Mw/Mn was 1.1. In the used PS-b-PDMS, the volume fraction of PDMS was about 16%, and it was found that upon performing the thermal annealing, a sphere pattern in which PDMS becomes spherical phases 51 and PS becomes the continuous phase 52, is expressed.

PS-b-PDMS and PDMS having a hydroxyl group on a termination were mixed to have a ratio of 8:2 by a weight ratio, and were dissolved in a solvent of propylene glycol 1-monomethyl ether 2-acetate (PGMEA), to adjust to a mixed polymer solution having a concentration of 1.0% by weight. This mixed polymer solution was dropped onto a surface of the substrate 10, the solvent was volatilized after spin coating, and a coating film was thereby formed on a surface of the substrate 10. At that time, by adjusting a rotation rate of a spin coater, a mixed coating film having a coating film thickness L of 20 nm was obtained.

A silicon substrate which was subject to surface treatment was used as the substrate 10.

After performing washing of the substrate 10 for 10 minutes by a UV washer before providing for the experiment, PS having a hydroxyl group on a termination was dropped onto the substrate, and a coating film was formed by spin coating. After that, thermal treatment was performed at 170° C. for 20 hours under a vacuum atmosphere, and a chemical adsorption layer of PS was formed on the substrate 10. After that, PGMEA was dropped onto the substrate 10, the surplus PS which was not used for the chemical adsorption was dissolved, and washing of the substrate was performed. Then, the solvent was volatilized by spinning, and the substrate 10 having the chemical adsorption layer of PS on the surface was obtained.

Next, by performing solvent annealing of the substrate 10 which formed a coating film, for 4 hours in a chamber in which N-methylpyrrolidone (NMP) which is a polar solvent was enclosed, a micro phase separation pattern was expressed in a polymer film C. The amounts of the solvent in the chamber were determined out by optically measuring the PS film thickness of the substrate obtained by manufacturing only PS on the substrate. Herein, the NMP concentration in the chamber was adjusted and film thickness was swelled 1.5 times the initial film thickness of PS, during the solvent annealing.

After the solvent annealing, the chamber was exhausted by a vacuum pump, NMP which was introduced into the film and was immediately deaerated, and the micro phase separation pattern was fixed.

The pattern of the obtained polymer film C was observed by an Optical Microscope (hereinafter, referred to as an OM), a Scanning Electron Microscope (hereinafter, referred to as an SEM), and an Atomic Force Microscope (hereinafter, referred to as an AFM).

With the OM observation, first, whether or not areas with different film thickness were macroscopically expressed in the polymer thin film C by the solvent annealing was investigated. As a result, in the OM observation, the variation of contrast was not obtained and uniform color tone was shown over the entire surface.

With the result described above, when the silicon compound was mixed into the polymer block copolymer, it was confirmed that the uniform film thickness was maintained even after the expression of the micro phase separation.

Next, arrangement of a pattern which was expressed by the micro phase separation using an inductively-coupled plasma (ICP) RIE apparatus and etching resistance were evaluated. First, etching of the PDMS layer which was formed on the surface of the polymer thin film was performed using CF₄ as process gas. The chamber pressure was set to 0.1 Pa, the coil RF power and the platen RF power were set to 100 W and 2 W, respectively, and the etching time was set to 10 seconds. Then, the etching of the continuous phase 52 configured by PS was performed using oxygen as the process gas. The chamber pressure was set to 0.1 Pa, the coil RF power and the platen RF power were set to 50 W and 15 W, respectively, and the etching time was changed to 80 seconds, 100 seconds, 110 seconds, 120 seconds, 130 seconds, 140 seconds, and 150 seconds, to perform the etching.

After that, the pattern shape and the arrangement of the samples manufactured in each etching time were checked by SEM observation. From the observation result by SEM, patterns having a dot shape were observed in all samples, the separation with the mixing of the homopolymer was not expressed, and it was confirmed that the uniform film was formed.

Pitch standard deviation of the dot patterns calculated from the SEM observation image with respect to each etching time is shown in the following Table 1.

### Comparative Example 1

### Effects of Arrangement and Mask Resistance Depending on Additive

The following comparative experiment was executed for investigating the change of the etching resistance when the homopolymer is not added.

PS-b-PDMS was used as the diblock copolymer. The number average molecular weight Mn of each block chain configuring PS-b-PDMS was the same as that of Example 1. A polymer solution in which a concentration was adjusted to 1.0% by weight was prepared using PGMEA as a solvent. The prepared polymer solution was dropped onto the substrate 10 which was subject to the surface treatment in the same manner as Example 1, and a coating film formed of polymer was formed by spin coating. A film thickness L of the formed coating film was 20 nm as was the film thickness in Example 1.

After expressing the micro phase separation pattern by the solvent annealing process as Example 1, the arrangement of the pattern expressed using ICP-RIE and the etching resistance were evaluated. The etching of the continuous phase 52 configured of PS was performed by changing the time in the same manner as Example 1, and the results obtained by the SEM observation are shown in the following Table 1.

### Comparative Example 2

### Effects of Arrangement for Phase Separation Due to Thermal Annealing, and Mask Resistance

The following comparative experiments were executed for investigating changes of etching resistance due to a difference in steps of generating the phase separation.

PS-b-PDMS was used as the diblock copolymer. The number average molecular weight Mn of each block chain configuring PS-b-PDMS was the same as Example 1. The polymer solution obtained by adjusting to the concentration of 1.0% by weight was manufactured using PGMEA as the solvent. The manufactured polymer solution was dropped onto the substrate 10 which was subject to the surface treatment which was the same as Example 1, and the coating film formed of the polymer was formed by performing spin coating. A film thickness L of the formed coating film was 20 nm, the same as Example 1.

The obtained coating film was subject to thermal treatment under a vacuum atmosphere at 170° C. for 20 hours, and a micro phase separation pattern of PS-b-PDMS was formed on the substrate 10. After that, according to Example 1, the arrangement of the pattern expressed using ICP-RIE and the etching resistance were evaluated. The etching of the continuous phase 52 configured with PS was performed by changing time in the same manner as Example 1, and the results obtained by the SEM observation are shown in the following Table 1.

TABLE 1

| | Example 1 | Comparative | Comparative |
|---|---|---|---|
| | Pattern pitch | Example 1 | Example 2 |
| Etching time | standard deviation | standard deviation | standard deviation |
| (seconds) | (nm) | (nm) | (nm) |
| 80 | 1.32 | 1.91 | 1.41 |
| 100 | 1.31 | 1.89 | 1.40 |
| 110 | 1.32 | 1.92 | 1.45 |
| 120 | 1.63 | 2.78 | 1.98 |
| 130 | 2.4 | 5.1 | 3.4 |
| 140 | 5.6 | — | 5.8 |
| 150 | — | — | — |

As shown in Table 1, when the standard deviation is small, the arrangement of the pattern is uniform, and it is considered that the standard deviation increases due to occurrence of the defect of pattern by the etching. That is, it was clear that the defect of the pattern of Example 1 started to be generated from 130 seconds from Table 1. The standard deviation was not calculable at 150 seconds. In addition, it was clear that the pitch standard deviation of the micro phase separation pattern of the sample obtained by adding the PDMS homopolymer obtained by the solvent annealing process was about 1.3 nm. This value was a slightly more suitable value than the value which was expressed in the micro phase separation by the thermal annealing manufactured in Comparative Example 2. It can be considered that this is because the value is the optimal volume fraction of PS and PDMS for expressing the micro phase separation by the addition of the PDMS homopolymer and the solvent annealing.

On the other hand, it was confirmed that the value of the pitch standard deviation of Comparative Example 1 was about 1.9 nm, and the value thereof was degraded compared to a case of the addition of the PDMS including a hydroxyl group. It can be considered that, since NMP is the solvent for dissolving the PS, the ratio of the volume fraction of PDMS and PS is beyond the ratio for generating the phase separation, and since the disorder phase separation pattern is expressed, the standard deviation is degraded.

In addition, it was clear that the defects of the mask formed by PDMS of Example 1 were generated from 120 seconds from the results of the standard deviation with respect to the etching time of Table 1. The film pitch was not measurable at 140 seconds and 150 seconds of etch. As a result, it was clear that the mask etching resistance of PDMS with respect to oxygen is improved by about 10% and 20% by the addition of the homopolymer. In addition, although it is a slight amount, it was clear that the etching resistance is improved in the sample manufactured by the thermal annealing of Comparative Example 2. This can be considered that, since the terminal of the added PDMS homopolymer is a hydroxyl group, the cross-linking reaction of PDMS is promoted when etching, and since the PDMS has a three-dimensional structure, the etching resistance is improved.

In addition, there were no significant changes in the size and pitch of the pattern due to addition and differences in the phase separation step.

### Example 2

### Effect of Solvent Annealing which Dissolves Only PS

Example 2 shows an example in which the spherical phase 51 formed of the PDMS in the same manner as Example 1 forms the polymer thin film 53 having a pattern which is arranged in the continuous phase 52 formed of PS on the substrate 10. At that time, as the solvent used in the solvent annealing, a solvent which dissolves only PS with respect to PS-b-PDMS was used.

In the Example, a diblock copolymer (PS-b-PDMS) in which the monomers are formed of PS and PDMS was used. In addition, as the homopolymer to be added, PDMS having a methyl group at the terminal was used.

In addition, regarding the number average molecular weight Mn of each block chain configuring PS-b-PDMS, the number average molecular weight Mn of the PS block chain was 11,700, the number average molecular weight Mn of the PDMS block chain was 2,900, and the molecular weight variation Mw/Mn was 1.07. In addition, the number average molecular weight Mn of the homopolymer to be added was 5,000 and the molecular weight variation Mw/Mn was 1.05. In the used PS-b-PDMS mixture, the volume fraction of PDMS was about 21%, and it was found that by performing thermal annealing, a sphere pattern in which PDMS becomes spherical phases and PS becomes a continuous phase, is expressed.

PS-b-PDMS and the homopolymer were mixed to have a ratio of 9:1 by a weight, and were dissolved in the PGMEA solvent, to adjust to a mixed polymer solution of diblock copolymer and homopolymer having a concentration of 1.0% by weight. This mixed polymer solution was dropped onto the surface of the silicon substrate 10 which was subject to the surface treatment in the same manner as Example 1, the solvent was volatilized after spin coating, and a coating film was formed on a surface of the substrate 10. At that time, by adjusting a rotation rate of a spin coater, a mixed coating film having a coating film thickness L of 20 nm was obtained.

Next, by performing solvent annealing of the substrate 10 having the coating film thereon for 4 hours in a chamber in which NMP which is a polar solvent was enclosed, a micro phase separation pattern was expressed in the polymer film. The NMP concentration in the chamber was adjusted and film thickness was swelled 1.3 times the initial film thickness of PS by the solvent annealing.

After the solvent annealing, air in the chamber was exhausted by a vacuum pump, NMP which was introduced into the film was immediately removed, and the micro phase separation pattern was fixed in the film.

From the OM observation, the film after the solvent annealing showed uniform color tone over the entire surface. With the result described above, when the silicon compound was mixed into the polymer block copolymer, it was confirmed that the uniform film thickness was maintained even after the expression of the micro phase separation.

Next, the arrangement of the pattern which was expressed by the micro phase separation using the ICP-RIE apparatus in the same manner as Example 1 and etching resistance were evaluated. After performing etching removal of the PDMS layer of the surface layer by CF₄, the etching of the continuous phase 52 configured by PS was performed using oxygen as the process gas. The chamber pressure was set to 0.1 Pa, the coil RF power and the platen RF power were set to 50 W and 15 W, respectively, and the etching time was changed to 80 seconds, 100 seconds, 110 seconds, 120 seconds, 130 seconds, 140 seconds, and 150 seconds, to perform the etching.

After that, the pattern shape and the arrangement of the samples manufactured in each etching time were checked by the SEM observation. From the observation result by SEM, patterns having a dot shape were observed in all samples, the separation with the mixing of the homopolymer was not expressed, and it was confirmed that the uniform film was formed.

Pitch standard deviation of the dot patterns calculated from the SEM observation image with respect to each etching time are shown in the following Table 2.

### Comparative Example 3

### When Using Solvent which Dissolves Both PS and PDMS

In the same manner as Example 2 except for using toluene as a solvent for solvent annealing, a coating film was formed, and after the micro phase separation by the solvent annealing, a micro phase separation pattern was fixed.

From the OM observation, the film after the solvent annealing showed uniform color tone over the entire surface.

For the obtained micro phase separation pattern, the arrangement of the pattern which was expressed by the micro phase separation and etching resistance were evaluated, in the same manner as Example 1.

From the observation result by SEM, it was confirmed that patterns having a dot shape were observed in all samples, however, it was confirmed that the separation with the mixing of the homopolymer was expressed.

Pitch standard deviation of the dot patterns calculated from the SEM observation image with respect to each etching time are shown in the following Table 2.

TABLE 2

| | | Comparative |
|---|---|---|
| | Example 2 | Example 3 |
| Etching time | standard deviation | standard deviation |
| (seconds) | (nm) | (nm) |
| 80 | 1.02 | 1.72 |
| 100 | 1.03 | 1.68 |
| 110 | 0.98 | 1.71 |
| 120 | 1.02 | 1.92 |
| 130 | 1.05 | 2.63 |
| 140 | 1.73 | 5.63 |
| 150 | 2.43 | — |

When the standard deviation is small, the arrangement of the pattern is uniform, and it is considered that the standard deviation increases due to occurrence of defects of the pattern by the etching, for example overetching of features to destroy the pattern.

It was clear that the defect of the pattern of Example 2 started to be generated from 140 seconds from Table 2. In addition, it was clear that the pitch standard deviation of the micro phase separation pattern obtained by the thermal treatment was about 1.0 nm.

In addition, it was clear that the defect of the pattern of Comparative Example 3 started to be generated from 120 seconds from Table 2.

It is considered that, when using the solvent which dissolves both PS and PDMS as the annealing solvent, it is difficult to locate the added homopolymer in the dots of PDMS formed by the diblock copolymer, the pattern shape is degraded, and the arrangement becomes disarranged.

### Example 3

### Maintenance of Phase Separation State

In Example 3, the confirmation of effects of suppressing the change of the phase separation state which occurs when changing the volume fraction by the solvent annealing was determined.

In the exemplary embodiment, PS-b-PDMS in which the number average molecular weight Mn of the PS block chain is 13,500, the number average molecular weight Mn of the PDMS block chain is 4,500, and the molecular weight variation Mw/Mn is 1.07 was used. As the silicon-contained homopolymer to be added, PDMS having a methyl group on a terminal in which the number average molecular weight Mn is 6,500 and the molecular weight variation Mw/Mn is 1.05 was used. In the used PS-b-PDMS mixture, the volume fraction of PDMS was about 25%, and it was found that by performing the thermal annealing, a cylindrical pattern in which PDMS becomes the columnar phase and PS becomes the continuous phase, is expressed.

PS-b-PDMS and the homopolymer were mixed to have a ratio of 9:1 by a weight ratio, and were dissolved in a PGMEA solvent, to adjust to a mixed polymer solution of diblock copolymer and homopolymer having a concentration of 1.0% by weight. This mixed polymer solution was dropped onto a surface of the silicon substrate 10 which was subject to the surface treatment which is the same as that of Example 1, the solvent was volatilized after spin coating, and a coating film was formed on a surface of the substrate 10. At that time, by adjusting a concentration and a rotation rate of a spin coater, a mixed coating film having a coating film thickness L of 25 nm was obtained.

Next, by performing solvent annealing of the substrate 10 which formed a coating film, for 4 hours in a chamber in which N, N-dimethylformamide (DMF) which is a polar solvent was enclosed, a micro phase separation pattern was expressed in the polymer film. The DMF concentration in the chamber was adjusted and film thickness was swelled 1.5 times the initial film thickness of PS by the solvent annealing.

After the solvent annealing, the chamber was exhausted by a vacuum pump, DMF which was introduced into the film was immediately deaerated, and the micro phase separation pattern was fixed.

Then, the evaluation of the pattern expressed by the micro phase separation was performed using the ICP-RIE apparatus in the same manner as Example 1, and the shape thereof was evaluated using SEM. As a result, it was clear that the cylindrical pattern in which PDMS becomes the columnar pattern is expressed, even after the solvent annealing.

This effect is not limited to the polymer which expresses the cylindrical pattern in the thermal annealing used in Example 3, however, the effects can be obtained in all phase separation shapes, such as the sphere pattern shown in Example 1 or Example 2, or the lamella pattern in which two kinds of polymers configuring the diblock copolymer form the sheet-like phase separation pattern with each other.

### Comparative Example 4

### Change of Phase Separation State Due to Additive

In Comparative Example 4, the change of the phase separation state due to the solvent annealing by the additive was confirmed.

In the Comparative Example, PS-b-PDMS in which the number average molecular weight Mn of the PS block chain is 13,500, the number average molecular weight Mn of the PDMS block chain is 4,500, and the molecular weight variation Mw/Mn is 1.07 in the same manner as Example 3 was used. The shape of the minute pattern of the coating film formed on the substrate 10 in the same manner as Example 3 except for not adding the homopolymer was evaluated by SEM. As a result, it was confirmed that, the obtained pattern becomes the sphere pattern in which the PDMS becomes dots, and the phase separation state is changed from the cylindrical pattern obtained by thermal annealing or that obtained in Example 3.

In addition, when the solvent amount at the time of solvent annealing was decreased and the solvent annealing was executed under an atmosphere in which the film thickness is swelled 1.3 times the initial thickness, it was clear that, in the pattern formed by the phase separation, the spheres in which PDMS becomes a spherical phase and cylinders in which PDMS becomes a columnar phase are mixed.

### Example 4

### Optimization of Added Amount of Homopolymer

In Example 4, the concentration of the homopolymer to be added was changed, and the expression of the micro phase separation, the arrangement of the pattern, and the etching resistance were evaluated in the same conditions as Example 2.

In the exemplary embodiment, PS-b-PDMS in which the number average molecular weight Mn of the PS block chain is 7,000, the number average molecular weight Mn of the PDMS block chain is 1,500, and the molecular weight variation Mw/Mn is 1.06 was used. As the homopolymer to be added, PDMS having a methyl group on a terminal in which the number average molecular weight Mn is 2,500 and the molecular weight variation Mw/Mn is 1.1 was used. In the used PS-b-PDMS, the volume fraction of PDMS was about 19%, and it was found that by performing the thermal annealing, the sphere pattern in which PDMS becomes the spherical phase and PS becomes the continuous phase, is expressed.

The mixing ratio of the homopolymer with respect to the total of PS-b-PDMS and the homopolymer was set to 0.05% by weight, 0.1% by weight, 1.0% by weight, 5.0% by weight, 10.0% by weight, 15.0% by weight, 20.0% by weight, 25.0% by weight, and 30.0% by weight, and PS-b-PDMS and homopolymer were dissolved in the PGMEA solvent, to adjust to a mixed polymer solution having a concentration of 1.0% by weight. This mixed polymer solution was dropped onto a surface of the silicon substrate 10 which was subject to the surface treatment which is the same as that of Example 1, the solvent was volatilized after spin coating, and a coating film was formed on a surface of the substrate 10. At that time, by adjusting a concentration and a rotation rate of a spin coater, a mixed coating film having a coating film thickness L of 13 nm was obtained.

Next, after performing solvent annealing using NMP in the same manner as Example 2, the OM observation was performed. The results thereof are shown in the following Table 3.

In the sample in which the mixing ratio of the homopolymer was equal to or less than 20% by weight of the liquid mixture, the uniform color tone was shown over the entire surface of the film after the solvent annealing. However, in the samples in which the mixing ratio were 25.0% by weight and 30.0% by weight, it was clear that, there were changes in the color tone of the film, the homopolymer added after the solvent annealing was aggregated, and the macro phase separation of PS-b-PDMS and the homopolymer occurred.

Then, the arrangement of the pattern expressed by the micro phase separation using the ICP-RIE apparatus and the etching resistance were evaluated in the same manner as Example 1. After performing etching removal of the PDMS layer of the surface layer by CF₄, the etching of the continuous phase 52 configured by PS was performed using oxygen as the process gas. The chamber pressure was set to 0.1 Pa, the coil RF power and the platen RF power were set to 50 W and 10 W, respectively, and the etching time was changed from 50 seconds to 130 seconds, to perform the etching.

For checking the generation of the minute macro phase separation which cannot be checked by the OM observation, the SEM observation of each sample in which PS continuous phase was etched at 50 seconds was performed.

The results thereof are shown in the following Table 3.

As a result, it was clear that, if the added amount of homopolymer has a ratio of 15.0% by weight or less, the macro phase separation is not expressed and a uniform pattern is formed. However, in the samples having the added amount with a ratio of 20.0% by weight or more, it was clear that the macro phase separation with a diameter of about 30 nm to 100 nm is expressed. It is considered that, if the added amount has a ratio of equal to or less than 15.0% by weight, it is absorbed to PDMS configuring the spherical phase in the conditions used in the exemplary embodiment and the PDMS layer formed on the outermost surface, and thus the macro phase separation does not occur, however, if the added amount has a ratio of equal to or more than 20% by weight, since the homopolymer with equal to or more than the allowed added amount exists on each PDMS layer, the macro phase separation occurs.

The adequate silicon added amount fluctuates depending on the molecular weight of the homopolymer to be added, or the diblock copolymer to be used and the conditions of the solvent annealing. However, in order to stabilize the state of the phase separation in the solvent annealing, using the diblock copolymer generally configuring as a sphere in the thermal annealing, it is considered that the added amount with a ratio of equal to or less than 20% by weight will improve the film while minute aggregation of the additive occurs.

Next, regarding the etching resistance of the micro phase separation pattern for each added amount, the etching time at which the loss of spheres occurs is shown in the following Table 3.

TABLE 3

| | | | Mask loss time |
|---|---|---|---|
| | | | (time for the mask |
| Added amount | OM | SEM | to be etched away) |
| (% by weight) | observation | observation | (seconds) |
| 0.05 | No separation | No separation | 45 |
| 0.1 | No separation | No separation | 65 |
| 1.0 | No separation | No separation | 75 |
| 5.0 | No separation | No separation | 80 |
| 10.0 | No separation | No separation | 81 |
| 15.0 | No separation | No separation | 82 |
| 20.0 | No separation | Separation | 80 |
| 25.0 | Separation | Separation | 81 |
| 30.0 | Separation | Separation | 82 |

From the results, it was clear that, when the added amount of homopolymer is equal to or less than 5.0% by weight, the time for etching away the spheres becomes longer according to the added amount, and the etching resistance of the PDMS mask tends to be improved. However, it was clear that, when the added amount has a ratio of more than 5.0% by weight, there are no significant changes in time when integrity is lost. From the results, it can be considered that, when the added homopolymer has a ratio of equal to or less than 5.0% by weight, the homopolymer is located on the spherical phase formed of PDMS, and when the added homopolymer has a ratio of more than 5.0% by weight, the homopolymer is eccentrically located on the PDMS layer formed on the surface. On the other hand, it was clear that, in the medium having the added amount with a ratio of 0.05% by weight, the mask etch through time is short. The reason thereof can be considered that, if the added amount is small, the biasing of the amount of the added homopolymer which is eccentrically located in the spheres formed of PDMS is generated. From this point, the added amount of homopolymer is preferably a ratio of 0.1% by weight to 20.0% by weight, and particularly preferably a ratio of 5.0% by weight to 20.0% by weight. In addition, when the uniform pattern is necessary over the entire surface, the added amount of homopolymer at a ratio of equal to or more than 5.0% by weight and equal to or less than 15.0% by weight is particularly preferable.

In addition, the optimal added amount largely depends on the degree of swelling of the film thickness in the solvent annealing. From this result, it is found that, in a state of the film thickness swelling to 1.3 times the initial film thickness, the uniform pattern is obtained when the added amount has a ratio of equal to or less than 15% by weight. When the degree of swelling is set to be higher, it is considered that the upper limit of the added amount is more than 15% by weight.

### Example 5

### Optimization of Molecular Weight of Additive

In Example 5, optimization of the molecular weight of the polymer to be added was performed. As the diblock copolymer, PS-b-PDMS in which the number average molecular weight Mn of the PS block chain is 7,000, the number average molecular weight Mn of the PDMS block chain is 1,500, and the molecular weight variation Mw/Mn is 1.06 was used. The molecular weight was set to 250, 1500, 2000, 3000, 5000, 7500, and 9000 using PDMS having a methyl group on a terminal as the homopolymer to be added.

PS-b-PDMS and homopolymer were mixed to have a ratio of 9:1 by a weight ratio, and were dissolved in a PGMEA solvent, to adjust to a mixed polymer solution of diblock copolymer and homopolymer having a concentration of 1.0% by weight. This mixed polymer solution was dropped onto a surface of the silicon substrate 10 which was subject to the surface treatment which is the same as that of Example 1, the solvent was volatilized after spin coating, and a coating film was formed on a surface of the substrate 10. At that time, by adjusting a concentration and a rotation rate of a spin coater, a mixed coating film having a coating film thickness L of 13 nm was obtained.

The samples after the annealing were etched using the solvent annealing which is the same as that of Example 2, and the arrangement of the pattern was checked. As a result, in the addition of the homopolymer with a molecular weight of equal to or less than 5000, it was confirmed that the uniform and minute pattern was formed. On the other hand, in the addition of the homopolymer with a molecular weight of 7500 and 9000, it was confirmed that the sphere pattern becomes disarranged. The reason for this is considered that, when the extremely large molecular weight is added with respect to PS-b-PDMS in which the number average molecular weight Mn of the used PS block chain is 7,000 and the number average molecular weight Mn of the PDMS block chain is 1,500, the phase separation pattern formed by PS-b-PDMS is degraded and the arrangement becomes disarranged. Accordingly, the molecular weight of the additive is preferably about 3 times the molecular weight of the block copolymer having affinity.

In addition, in a coating property with respect to a disk-shaped substrate such as a magnetic recording medium, when the additive having a molecular weight of equal to or more than 2000 is added, it was clear that the uniformity of the film is improved. Accordingly, the molecular weight of the polymer to be added is particularly preferably equal to or more than 2000.

In addition, for the polymer to be added, the examples with only PDMS were described, however, the polymer may be suitably selected with respect to the diblock copolymer to be used. In the diblock copolymer having PDMS particularly, other than PDMS shown in the exemplary embodiment, a polymer having small surface energy such as a polymer having Spin-On Glass or siloxane may be added, and this effect is not obtained in the terminal structure of the polymer.

However, when the polymer having a hydroxyl group or a methoxy group on the terminal of the polymer is added, it is possible to decompose only the terminal of the polymer by the ultraviolet light, the three-dimensional cross-linking reaction proceeds, and the mask etch resistance can be further improved.

### Example 6

### Transfer to Magnetic Recording Medium

In Example 6, a process of transferring the manufactured phase separation pattern to the magnetic recording medium using the same polymer as that of Example 2 is shown.

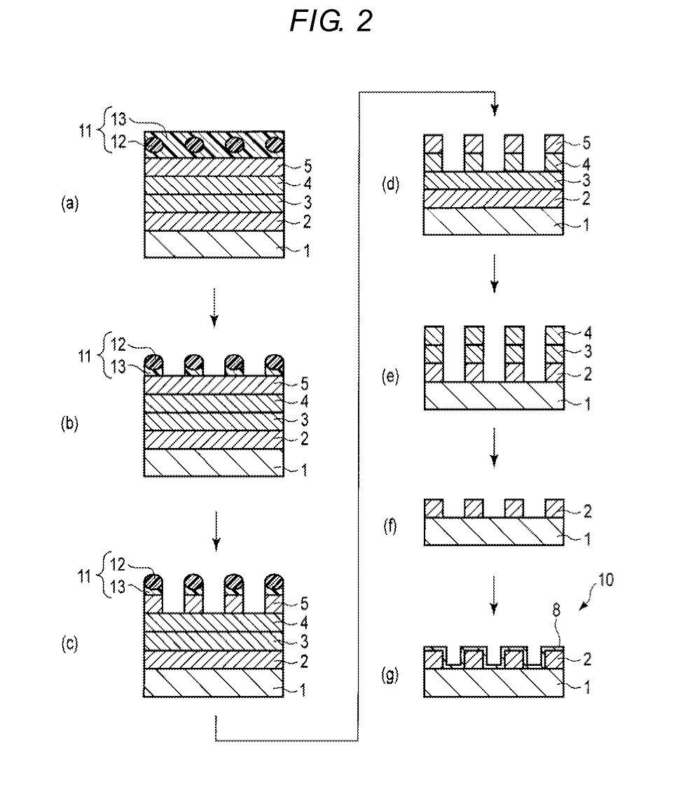

FIGS. 2A to 2G show views showing a manufacturing step of the magnetic recording medium according to the exemplary embodiment.

In the same manner as Example 2, the mixed polymer solution was manufactured and coating onto a laminated substrate 11 was performed. The film thickness was set to 20 nm. For the laminated substrate 11, the manufacturing of the substrate was performed with the method as will be described below.

A glass substrate 1 (amorphous substrate MEL 6 manufactured by Konica Minolta, Inc. having a diameter of 2.5 inches) was accommodated in a film-forming chamber of a DC magnetron sputtering system (C-3010 manufactured by CANON ANELVA CORPORATION), and the air in the film-forming chamber was exhausted until a final vacuum became 1×10⁻⁵ Pa. CrTi was formed with a thickness of 10 nm on this substrate 1, as an adhering layer (not shown). Then, CoFeTaZr was formed with a thickness of 40 nm as a soft magnetic layer (not shown) to form a soft magnetic layer. Ru was formed with a thickness of 10 nm as a non-magnetic base layer (not shown). After that, Co-20 at % Pt-10 at % Ti was formed with a thickness of 10 nm as a perpendicular magnetic recording layer 2. Then, an Mo film was formed with a thickness of 5 nm as a release layer 3, a C film was formed with a thickness of 30 nm as a mask layer 4, and Si which is an auxiliary mask 5 for transferring the pattern to the C mask was formed with a thickness of 5 nm on the C mask layer 4. After that, the surface treatment was performed on the auxiliary mask 5 in the same manner as Example 1, and the chemical adsorption layer of PS was formed on the surface of the auxiliary mask 5.

As shown in (a) of FIG. 2, in the same manner as Example 2, a coating film containing the diblock copolymer (PS-b-PDMS) in which the monomers are formed of PS and PDMS and the PDMS homopolymer having a methyl group on the terminal was formed on the auxiliary mask 5 including the chemical adsorption layer of PS, and a phase separation pattern in which a self assembled pattern of polydimethylsiloxane 12 islands in the polystyrene 13 layer of the coating film is formed.

After that, a bit patterned medium (BPM) was manufactured as described below.

A concavo-convex pattern was formed in the coating film 11 using the ICP-RIE apparatus by selective etching based on the phase separation pattern. First, for removing PDMS on the surface layer of the self-assembled film, the coil RF power and the platen RF power were set to 50 W and 5 W, respectively and etching for 7 seconds was performed using CF₄ as process gas. Then, for removing PS of the continuous film, the coil RF power and the platen RF power were set to 50 W and 15 W, respectively and etching for 120 seconds was performed using O₂ as process gas. Accordingly, as shown in (b) of FIG. 2, a concavo-convex pattern formed of the diblock copolymer was formed. With the etching by the oxygen used herein, Si becomes an etch stop and the etching is completed.

Further, as shown in (c) of FIG. 2, the concavo-convex pattern was transferred to the auxiliary mask 5. In the same manner as the concavo-convex formation in the self-assembled film, the processing of the auxiliary mask 5 was performed by ICP-RIE. Once the pattern was transferred to the auxiliary mask 5, the Si layer was removed by setting coil RF power and the platen RF power to 50 W and 5 W, respectively and etching for 40 seconds using CF₄ as process gas.

After that, the pattern transfer to the C mask 4 was performed with the pattern in the auxiliary mask 5 as shown in (d) of FIG. 2. Using ICP-RIE, the coil RF power and the platen RF power were set to 100 W and 10 W, respectively and etching for 80 seconds was performed using O₂ as process gas.

After that, as shown in (e) of FIG. 2, by Ar ion milling, the milling process of Mo which is the release layer 3 and the magnetic recording layer 2 was performed, and the phase separation pattern formed by PS-b-PDMS was ultimately transferred to the magnetic recording layer 2.

Subsequently, the Mo layer 3 is immersed in H₂O₂, resulting in the peeling off or removal of the Mo layer and the mask layer 4. After preparing H₂O₂ of 1% by weight, by adding a nonionic fluorine-contained surfactant thereto, it becomes a peeling-off liquid, and the peeling-off was performed by immersing the sample therein. Accordingly, as shown in (f) of FIG. 2, the concavo-convex pattern was formed on the magnetic recording layer 2 on the substrate 1.

After that, as shown in (g) of FIG. 2, the magnetic recording medium 10 was obtained by forming a protective film 8 and a lubrication film (not shown) over the resulting pattern.

It was found that, when a pattern defect rate of the medium obtained by the above processing was evaluated, it was 0.8%. In addition, as a result of performing evaluation of floating characteristics of a head on the manufactured medium, when the floating amount of the head is 5 nm, errors did not occur, and excellent head floating characteristics could be obtained.

### Comparative Example 5

### Uniformity Evaluation of Polymer Film Thickness to Perforated Substrate Due to Addition of Homopolymer

In the same manner as Example 6, a thin film of the diblock copolymer was formed on the magnetic recording medium, and the uniformity of the film thickness to the substrate due to the added monomer was evaluated. The uniformity of the film thickness and the thin film formation start position of the obtained polymer film were evaluated using an optical interference type film thickness measuring device and an Optical Surface Analyzer (hereinafter, referred to as OSA). The results thereof are shown in the following Table 4.

TABLE 4

| Added amount | | |
|---|---|---|
| of monomer | Film thickness | Deviation of thin film |
| (% by weight) | variation | formation position |
| 0 | X | X |
| 2 | Δ | ◯ |
| 5 | ◯ | ⊙ |
| 10 | ◯ | ⊙ |
| 15 | ◯ | Δ |
| 20 | Δ | X |

As a result, in the substrate in which the addition was not performed, it was found that the requirements for the film thickness variation in the radial direction and the formation start position of the thin film were not satisfied. If the amount of PDMS on the methyl termination used as the added monomer was increased, the film thickness variation and the thin film formation position deviation improved, and when the added amount was 5.0% by weight to 10.0% by weight, the requirements for the film thickness variation and the thin film formation position were satisfied.

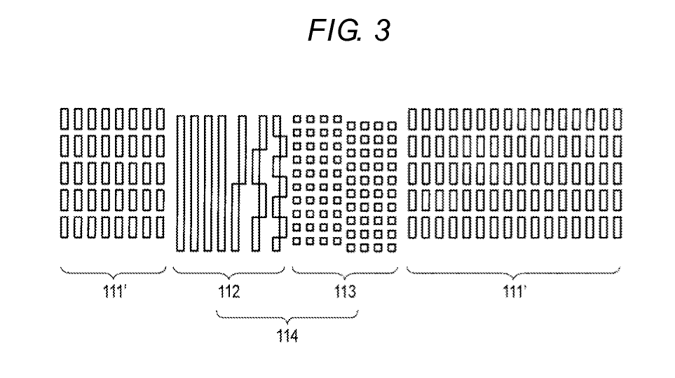

FIG. 3 shows a view showing an example of the recording bit pattern with respect to a circumferential direction of the magnetic recording medium, as an example of the concavo-convex pattern of the magnetic recording layer.

As shown in FIG. 3, the concavo-convex pattern of the magnetic recording layer is broadly divided into a recording bit area 111′ for recording data corresponding to 1 and 0 of digital signals, and a so-called servo area 114 formed of a preamble address pattern 112 and a burst pattern 113 which are positioning signals of the magnetic head, and this can be formed as an in-plane pattern. In addition, the pattern of the servo area shown in the drawing may not be a rectangular shape, and for example, the entire servo pattern may be substituted with the dot shape. Further, in addition to the servo, the entire data area can be configured with the dot pattern. Information of 1 bit can be configured with one magnetic dot or a plurality of magnetic dots.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern forming method comprising:
forming a diblock copolymer coating film by applying coating liquid containing a diblock copolymer including a chain of a first polymer and a chain of a second polymer which is not compatible with the first polymer, and a homopolymer having affinity with the first polymer, on a substrate, and drying the liquid;
performing phase separation of the first polymer and the second polymer by solvent annealing the diblock copolymer film using a solvent having compatibility with the second polymer; and
forming a pattern on the substrate by removing one of the first polymer and the second polymer from the film.

2. The method according to claim 1, wherein a content of the homopolymer is 0.1% by weight to 20% by weight with respect to the total amounts of the diblock copolymer and the homopolymer.

3. The method according to claim 1, wherein the solvent used for the solvent annealing is a solvent which dissolves only a continuous phase of a polymer thin film after the phase separation of the film.

4. The method according to claim 1, wherein the diblock copolymer is polystyrene-polydimethylsiloxane.

5. The method according to claim 1, wherein the homopolymer is a polymer containing silicon.

6. The method according to claim 1, wherein the step of forming a pattern on the substrate by removing one of the first polymer and the second polymer from the film is formed by selective etching.

7. The method of claim 6, wherein the etching is plasma etching.

8. The method of claim 1, wherein the pattern is formed by self assembly.

9. The method of claim 1, wherein the resulting pattern has a smaller standard deviation in pitch than a pattern made without a homopolymer using the same diblock copolymer.

10. A method of manufacturing a magnetic recording medium comprising:
forming a magnetic recording layer on a substrate;
forming a mask layer on the magnetic recording layer;
forming a diblock copolymer coating film by applying coating liquid containing a diblock copolymer including a chain of a first polymer and a chain of a second polymer which is not compatible with the first polymer, and a homopolymer having affinity with the first polymer, on a substrate, and drying the liquid;
performing phase separation of the first polymer and the second polymer by solvent annealing the diblock copolymer film using a solvent having compatibility with the second polymer; and
forming a pattern on the substrate by removing one of the first polymer and the second polymer from the film transferring the pattern to the mask layer;
etching the magnetic recording layer through the mask layer of the convex pattern; and
removing the mask layer.

11. The method of manufacturing a magnetic recording medium according to claim 10, further comprising the step of forming the pattern by selectively etching one of the first polymer and the second polymer to provide a masking layer having projections therein where the selected polymer layer has been etched away.

12. The method of manufacturing a magnetic recording medium according to claim 11, wherein the homopolymer is a polymer containing silicon.

13. The method of manufacturing a magnetic recording media according to claim 11, wherein the etching is plasma etching.

14. The method of manufacturing a magnetic recording media according to claim 11, wherein the pattern is formed by self assembly.

15. The method manufacturing a magnetic recording media according to claim 11, wherein the resulting pattern has a smaller standard deviation in pitch than a pattern made without a homopolymer using the same diblock copolymer.

16. A magnetic recording medium which is manufactured by the method of:
forming a magnetic recording layer on a substrate;
forming a mask layer on the magnetic recording layer;
forming a diblock copolymer coating film by applying coating liquid containing a diblock copolymer including a chain of a first polymer and a chain of a second polymer which is not compatible with the first polymer, and a homopolymer having affinity with the first polymer, on a substrate, and drying the liquid;
performing phase separation of the first polymer and the second polymer by solvent annealing the diblock copolymer film using a solvent having compatibility with the second polymer; and
forming a pattern on the substrate by removing one of the first polymer and the second polymer from the film transferring the pattern to the mask layer;
etching the magnetic recording layer through the mask layer of the convex pattern; and
removing the mask layer.

17. The magnetic recording medium of claim 16, wherein the method further comprises forming the pattern by selectively etching one of the first polymer and the second polymer to provide a masking layer having projections therein where the selected polymer layer has been etched away.

18. The magnetic recording medium of claim 16, wherein the homopolymer is a polymer containing silicon.

19. The magnetic recording medium of claim 16, wherein the etching is plasma etching.

20. The magnetic recording medium of claim 16, wherein the pattern has a smaller standard deviation in pitch than a pattern made without a homopolymer using the same diblock copolymer.
